(19) United States
(12) Patent Application Publication
(10) Pub. No.: US 2011/0216016 A1
(43) Pub. Date: Sep. 8, 2011

(54) Touch Sensor With Active Baseline Tracking

(75) Inventor: Douglas K. Rosener, Santa Cruz, CA (US)

(73) Assignee: Plantronics, Inc., Santa Cruz, CA (US)

(21) Appl. No.: 12/719,231

(22) Filed: Mar. 8, 2010

(51) Int. Cl. G06F 3/041

(52) U.S. Cl. 345/173; 178/18.03

(57) ABSTRACT

Methods and apparatuses for touch sensing are disclosed. In one example, both an inactive state baseline level and an active state baseline level are utilized.

### BACKGROUND OF THE INVENTION

Touch sensors determine whether a user is in contact with the sensor and are used in a variety of applications. For example, touch sensors are used in touch pads to determine a user touch input. Various sensing techniques are used in touch sensors, including capacitive, inductive, and infrared parameter measurement techniques. In typical operation, the touch sensor system monitors a sensor signal to update a signal baseline level when the touch sensor is inactive. When a touch input occurs, the resulting sensor signals are referenced to the baseline level. Touch is determined by identifying a jump in the sensor signals from the baseline level which exceeds a threshold value.

Errors are introduced into the touch sensing process by a variety of factors, including errors in the baseline level. As a result, improved methods and apparatuses for touch sensing are needed.

### BRIEF DESCRIPTION OF THE DRAWINGS

The present invention will be readily understood by the following detailed description in conjunction with the accompanying drawings, wherein like reference numerals designate like structural elements.

FIG. 1 illustrates a block diagram of a touch sensor system in one example.

FIG. 2 is a flow diagram illustrating a process for sensor touch sensing in one example.

FIG. 3 is a flow diagram illustrating a process for sensor touch sensing in a further example.

FIGS. 4A and 4B are a flow diagram illustrating a process for adjustment of a baseline level in one example.

FIG. 5 illustrates a plot of signal values and baseline level values during operation of a process utilizing an active state baseline level in one example.

FIG. 6 illustrates a plot of signal values and baseline level values during operation of a process utilizing an active state baseline level in a further example.

FIG. 7 illustrates a plot of signal values and baseline level values during operation of a process for adjustment of a baseline level in one example.

FIG. 8 is a flow diagram illustrating a process for a sensor utilizing an active state baseline tracking mode and active state baseline tracking mode in one example.

FIG. 9 is a diagram illustrating various operating regions for a touch sensor in one example.

FIG. 10 illustrates a block diagram of a headset utilizing the touch sensor touch sensor controller in one example.

### DESCRIPTION OF SPECIFIC EMBODIMENTS

Methods and apparatuses for touch sensing are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

Touch sense solutions typically utilize a baseline level and a fixed or adaptive active state threshold parameter to determine user touch activity, where the baseline level is typically a measured parameter when the touch sensor is known to be inactive. Errors are introduced into the touch sensing process by a variety of factors. Most parameter measurement systems will drift with environment. For example, the drift can result from sensor aging, temperature, humidity, or mechanical factors. The drift can also be due to internal electronics of the measurement system, or slow mechanical or electrical changes of the parameter being measured. Without correction, this drift can cause the measured value to drift towards the trigger threshold, making it easier to trigger or eventually triggering the sensor. The drift can also be away from the threshold making it more difficult or impossible to trigger.

If the sensor is in an active state for an extended period of time, it is possible for the baseline level to drift down below an active state threshold, so that the system drifts to an inactive state while it is still being touched. Similarly, it is possible for the baseline level to drift higher into the active state when the system has been inactive for an extended period of time while it is still not touched. Temperature and drop effects can cause significant changes to calibration of the sensors, especially for low-sensitivity ones.

Most implementations of these touch technologies utilize a tracking mechanism when the sensor is inactive (i.e., not being touched) to keep the baseline up-to-date with the environment. The parameter is regularly sampled and if it differs from the current baseline by a specified amount over a sufficiently long time, the baseline is update by a small amount to track the change in the parameter. In this manner, only the change in the parameter is observed, and drift effects are eliminated. This method is often referred to as the track-baseline method.

However, the inventor has recognized that this method is problematic in that if significant drift occurs while the touch sensor is activated, the baseline can be incorrect on release, as it is only tracked when the sensor is inactive. For extended touch applications where the system senses the worn state of a device by monitoring it touching the head or wrist, this problem is significant. Devices such as headsets and watches are worn for hours at a time. Under these conditions no drift correction will take place utilizing the techniques of the prior art. It is likely that significant drift will occur if the device is being used outside in freezing weather and the user enters a heated office, resulting in the sampled parameter drifting passed the threshold.

In one example of the invention, a baseline is tracked in both a sensor inactive state and a sensor active state. The sensor creates a temporary active-baseline to perform tracking when in the active state. When the sensor is inactive, the inactive-baseline is tracked by periodic monitoring of the sampled parameter. If the sampled parameter (possibly time-filtered or averaged) exceeds or falls below the inactive-baseline by a specified amount the inactive-baseline is incremented or decremented accordingly. If the change is slow enough, the inactive-baseline stored value will reflect the changing environment. When the sensor becomes active for a specified period (to avoid false tracking due to transients), an active-baseline is created by sampling the current sensor parameter value.

In one example embodiment, the active baseline is stored separately from the inactive-baseline at the time the active tracking begins. The system monitors the sampled parameter. If the sampled parameter (possibly time-filtered or averaged) exceeds/falls-below the active-baseline by a specified amount, both the active and inactive-baselines are incremented or decremented accordingly. If desired, any sudden change in the measured parameter larger than a specified threshold can take the system out of active-tracking mode, and the system goes back to normal measurement mode (requiring the active state to occur for a certain period before active-tracking again). In a further embodiment, the inactive baseline is incremented or decremented accordingly only when the system returns to normal measurement mode.

The methods and apparatuses described herein provide several advantages. For example, by tracking while in the active state, drift effects are compensated for even during extended periods of touching. This prevents false states due to drift while in the active sensor state. In another example, use is made of existing touch sensor drift-tracking methods. This eliminates the need for rewriting library software or hard-coded behavior that might be difficult in some implementations.

In one example, a method for determining sensor touch activity includes receiving a series of sensor signal values, determining a no touch inactive sensor state from the series of sensor signal values utilizing an inactive state baseline level, and adjusting the inactive state baseline level responsive to the sampled sensor signal values during the no touch inactivity state. In one example, the initial inactive baseline is determined through a calibration process. The threshold to detect initial active state is a design parameter. The initial active baseline is the value of the signal when tracking begins. The method further includes determining an active sensor touch state from the series of sensor signal values utilizing the inactive state baseline level, and establishing an active state baseline level during the active sensor touch state, where the active state baseline level is adjusted responsive to the sampled sensor signal values during the active sensor touch state. The method further includes determining a no touch inactive sensor state or an active sensor touch state from the series of sensor signal values utilizing the active state baseline level during the active sensor touch state.

In one example, a method for determining sensor touch activity includes sampling a series of sensor signal values, entering an active sensor touch state associated with user touch activity at a sensor, and setting an active state baseline level during the active sensor touch state. The method further includes adjusting the active state baseline level responsive to the series of sensor signal values to establish an adjusted active state baseline level, and determining a no touch inactive sensor state from the series of sensor signal values utilizing the adjusted active state baseline level.

In one example, a method for determining sensor touch activity includes receiving a series of sensor signal values and entering an active sensor touch state tracking mode associated with user touch activity at a sensor, where during the active sensor touch state tracking mode an active state baseline level is adjusted responsive to the series of sensor signal values. The method further includes determining a no touch inactive sensor state from the series of sensor signal values utilizing the active state baseline level, and departing the active sensor touch state tracking mode and entering a normal tracking mode if the series of sensor signal values exceed a threshold noise level. During normal tracking mode an inactive state baseline level is utilized to determine touch activity at the sensor.

In one example, a method for determining sensor touch activity includes receiving a series of sensor signal values, determining a no touch inactive sensor state from the series of sensor signal values utilizing a baseline level, and adjusting the baseline level responsive to the sampled sensor signal values. The method further includes determining an active sensor touch state from the series of sensor signal values utilizing the baseline level, determining a stuck-on activity state, and setting the baseline level to a current sampled sensor signal value responsive to determining the stuck-on activity state. The baseline level is further adjusted using the sampled sensor signal values to produce an adjusted baseline level. The method further includes setting a true-state variable to active responsive to determining the stuck-on activity state, setting the adjusted baseline level to a current sampled sensor signal value responsive to the series of sensor signal values exceeding a predetermined threshold for a predetermined period of time, and setting the true-state variable to inactive responsive to the series of sensor signal values exceeding a possibly different predetermined threshold for a possibly different predetermined time. In the examples described herein, counters may be utilized as timers to determine predetermined times, where the counters are incremented with each scan/pass of the sensor signal.

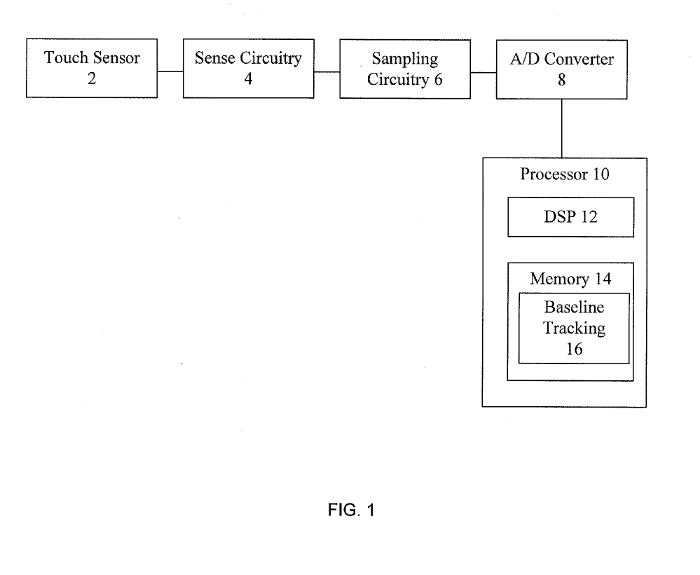

FIG. 1 illustrates a block diagram of a touch sensor system in one example. A touch sensor 2 is coupled to sense circuitry 4. The touch sensor 2 may utilize a variety of sensing technologies, including capacitive, inductive, and infrared techniques. Touch sensor 2 produces a sensor signal responsive to a user touch action at the sensor. The sensor signal is detected by sense circuitry 4. Analog voltages representing the user touch action are generated by the sense circuitry 4. The analog voltages are sampled by sampling circuitry 6. Sampling circuitry samples the analog voltages at a rate sufficient to produce a representation of the signals sufficient to determine a touch action. Sampled signals are output from the sampling circuitry 6 to an analog to digital (A/D) converter 8 where the analog signals are digitized.

The digitized sensor signal samples are output to a processor 10 for further signal processing and calculations to determine the presence of a touch action or lack of a touch action at touch sensor 2. The processor circuitry 10 may be coupled to a memory 14 for storage of, for example, data representing the sampled touch signal, as well as various touch sensor calibration parameters, including an inactive state baseline level and active state baseline level as described herein. For example, processor 10 may execute a baseline tracking application 16 to track and adjust an inactive state baseline level and an active state baseline level utilized in determining the sensor touch state. The processor 10 may perform a variety of controller functions, including controlling the A/D converter 8. In one example, sense circuitry 4, sampling circuitry 6, A/D converter 8, and processor 10 are located within a controller, which may be implemented on an integrated circuit chip.

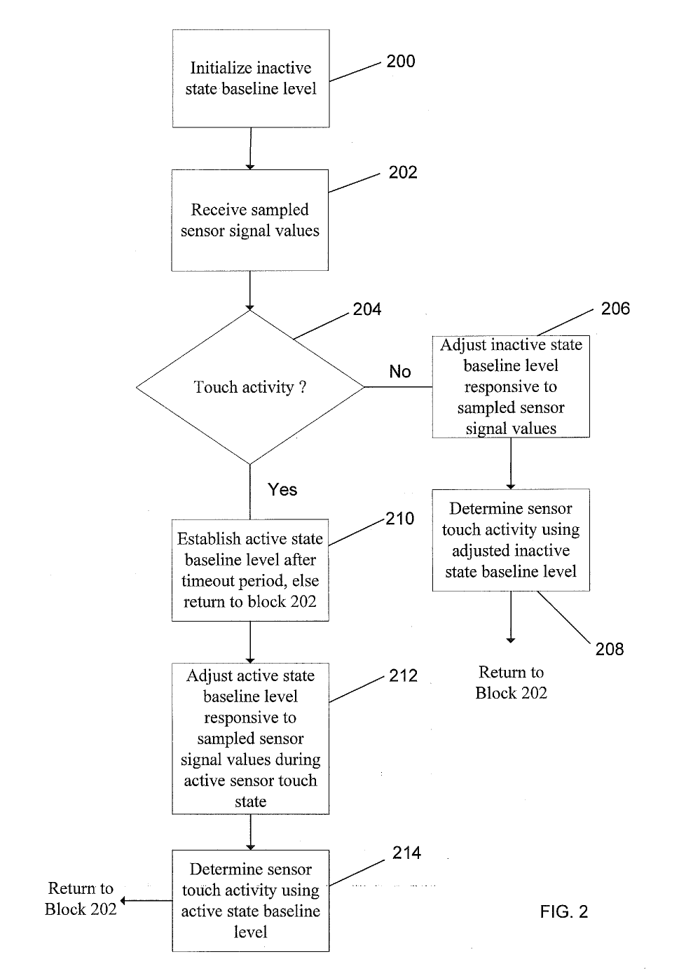

FIG. 2 is a flow diagram illustrating a process for sensor touch sensing in one example. At block 200, an inactive state baseline level is initialized. At block 202, the next available series of sampled sensor signal values are received. At decision block 204, it is determined whether there is user touch activity at the sensor utilizing the inactive state baseline level and the active threshold. In a headset application, the no touch inactive sensor state corresponds to a headset not worn on the user ear state (referred to herein as DOFF) and the active sensor touch state corresponds to a headset worn state on the user ear (referred to herein as DON).

If no at decision block 204, at block 206 the inactive state baseline level is adjusted responsive to the sampled sensor signal values during the no touch inactivity state. In one example, the inactive state baseline level is reset to a last sampled value if the last sampled value in the series of sampled sensor signal values exceeds a predetermined threshold above or below the inactive state baseline level during a no touch inactive sensor state. At block 208, sensor touch activity is determined using the adjusted inactive state baseline level. Following block 208, the process returns to block 202 to receive the next sensor signals.

If yes at decision block 204, an active state baseline level is established at block 210. In one example, the active state baseline level is established a fixed time period after determination of the active sensor touch state. At block 212, the active state baseline level is adjusted responsive to the sampled sensor signal values during the active sensor touch state. If a no touch determination is made prior to the end of the time period, the process returns to block 202. In one example, the active state baseline level is adjusted responsive to the sampled sensor signal values during the active sensor touch state by incrementing or decrementing the active state baseline level responsive to a time-averaged series of sampled sensor signal values falling above or below the active state baseline value by an amount within a predetermined threshold. In one example, the inactive state baseline level is simultaneously adjusted responsive to an adjustment of the active state baseline level. At block 214, sensor touch activity is determined using the adjusted active state baseline level during the active sensor touch state. Following block 214, the process returns to block 202 to receive the next sensor signals.

In one example, determining a no touch inactive sensor state or an active sensor touch state from the series of sampled sensor signal values utilizing the active state baseline is terminated if a signal value exceeds a predetermined threshold value. The exceeding of noise indicates to use the inactive state baseline, but it is not necessarily an inactive state, and may be an actual increase in signal, or a weak decrease in signal but still maintaining the active sensor touch state. For example, the predetermined threshold value is a predetermined noise level value associated with an active sensor touch state. Following such termination, a no touch inactive sensor state or an active sensor touch state is determined from the sensor signal values utilizing the inactive state baseline level.

In one example, the inactive state baseline level is adjusted responsive to a previous adjustment of the active state baseline level after terminating determining a no touch inactive sensor state or an active sensor touch state utilizing the active state baseline level. The inactive state baseline level is adjusted prior to determining a no touch inactive sensor state or an active sensor touch state from the series of sampled sensor signal values utilizing the inactive state baseline level.

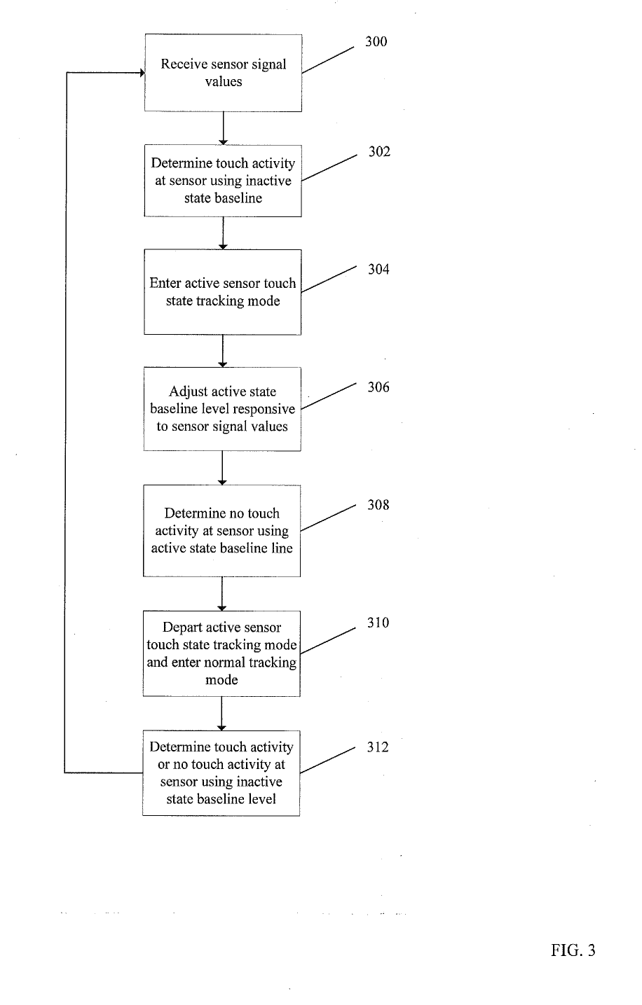

FIG. 3 is a flow diagram illustrating a process for sensor touch sensing in a further example. At block 300, the next available series of sensor signal values are received. At block 302, touch activity at the sensor is determined. At block 304, an active sensor touch state tracking mode associated with user touch activity at the sensor is entered. In one example, an active state baseline level is initialized at a fixed time after entering the active sensor touch state. At block 306, during the active sensor touched state tracking mode the active state baseline level is adjusted responsive to the series of sensor signal values. In one example, during the active sensor touch state tracking mode the active state baseline level is adjusted by incrementing or decrementing the active state baseline level responsive to the series, of sensor signal values falling above or below the active state baseline value by an amount within a predetermined threshold.

At block 308, a no touch inactive sensor state is determined from the series of sampled sensor signal values utilizing the active state baseline level. For example, the sensor signals may exceed a predetermined threshold such as a noise threshold. At block 310, the active sensor touch state tracking mode is departed and a normal tracking mode is entered if the series of sampled sensor signal values exceed a threshold noise level. In one example, even if the sensor does not exit a touch state, the active sensor touch state tracking mode is departed when the signal exceeds a noise level and normal tracking mode returns using the inactive state baseline level to determine touch activity. At block 312, during normal tracking mode an inactive state baseline level is utilized to determine touch activity at the sensor. In one example, the inactive state baseline level is adjusted responsive to the series of sensor signal values. Following block 312, the process returns to block 300.

In one example, the inactive state baseline level is adjusted during active tracking mode responsive to the active state baseline level being adjusted. In a further example, the inactive state baseline level is adjusted at the time the active sensor touch state tracking mode is departed and the normal tracking mode is entered.

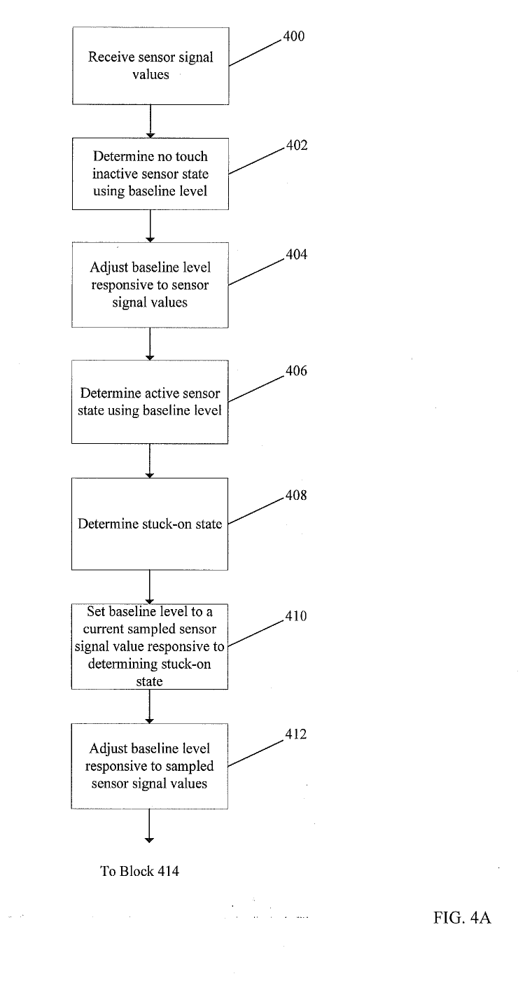

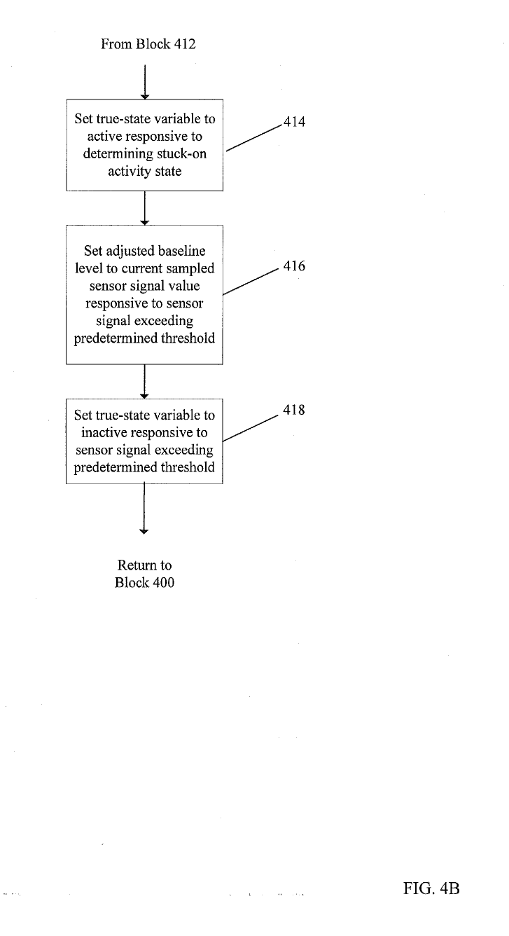

FIGS. 4A and 4B are a flow diagram illustrating a process for adjustment of a baseline level in one example. In this example embodiment, an existing measurement system's functions are used to perform the active mode tracking. In particular, inherent stuck-on and snap-baseline methods are used. The stuck on method resets the baseline to the current measured value if the sensor has been active more than a specified time. This changes the sensor state from active to inactive and drift-tracking resumes. In the snap baseline method, the measured parameter is monitored when it is inactive. If the measured parameter is below or above the current baseline by a certain amount (but not triggering the active state), for a certain period of time, the baseline is reset to the current measured value rather than tracked.

In one example, the no touch inactive sensor state corresponds to a headset DOFF state and the active sensor touch state corresponds to a headset DON state. When the DON state is triggered, the system behaves as in the prior art. However, when the stuck-on method occurs, a TRUE_STATE variable is set to DON. This tracks normally and will adjust itself to minor variations in the DON state. When the touch is removed, the snap-baseline method occurs and the TRUE_STATE variable is set to DOFF. There is no need to store the baseline and correct it.

At block 400, the next available series of sampled sensor signal values are received. At block 402, a no touch inactive sensor state is determined from the series of sampled sensor signal values utilizing a baseline level. At block 404, the baseline level is adjusted responsive to the sensor signal values. At block 406, an active sensor touched state is determined from the series of sampled sensor signal values utilizing the baseline level. At block 408, a stuck-on activity state is determined. In one example, determining a stuck-on activity state from the series of sampled sensor signal values is done by determining whether a time period of the active sensor touch state exceeds a pre-determined stuck-on time.

At block 410, the baseline level is set to a current sampled sensor signal value responsive to determining the stuck-on activity state. During the stuck-on activity state, at block 412 the baseline level is further adjusted responsive to the sampled sensor signal values. At block 414 a true-state variable is set to active responsive to determining the stuck-on activity state. Alternatively, the true-state variable is set to active immediately following block 408. At block 416, the adjusted baseline level is set to a current sampled sensor signal value responsive to the sensor signal exceeding a predetermined threshold. At block 418, the true-state variable is set to inactive responsive to the sensor signal exceeding a predetermined threshold. Following block 418, the process returns to block 400.

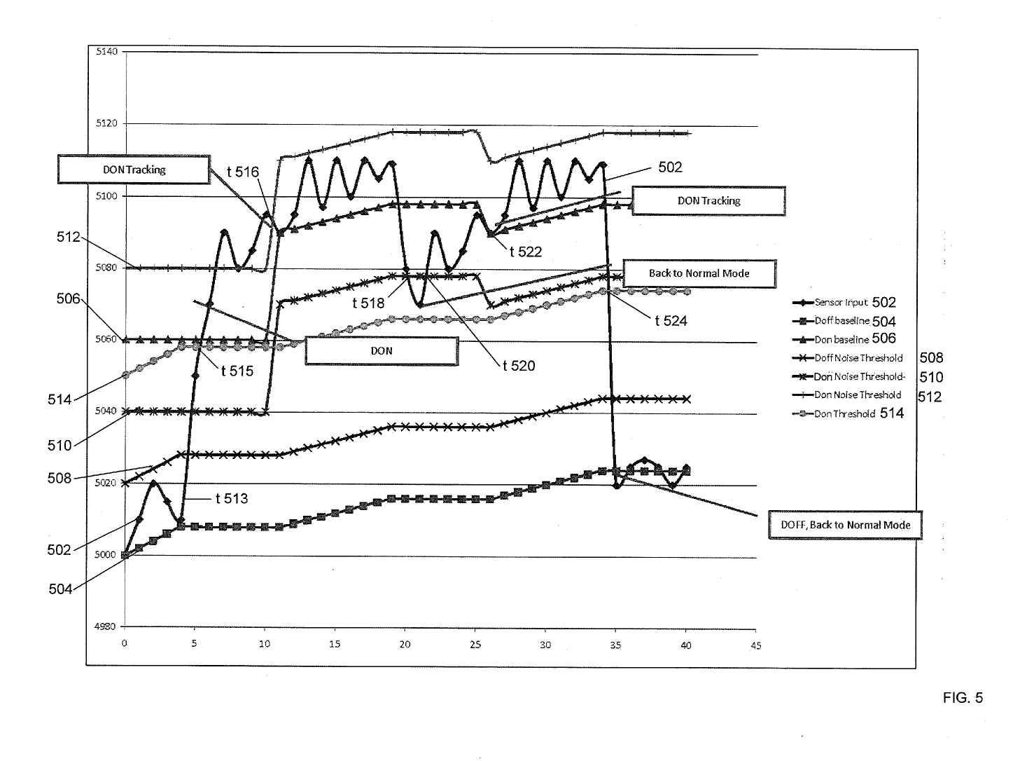

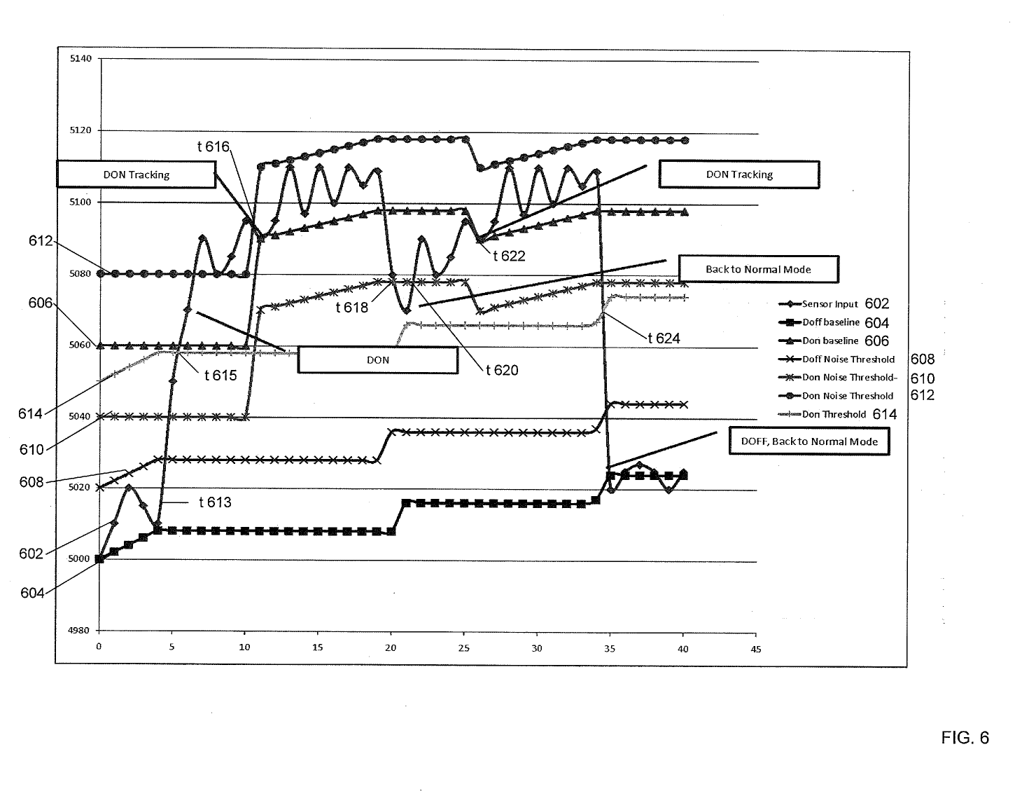

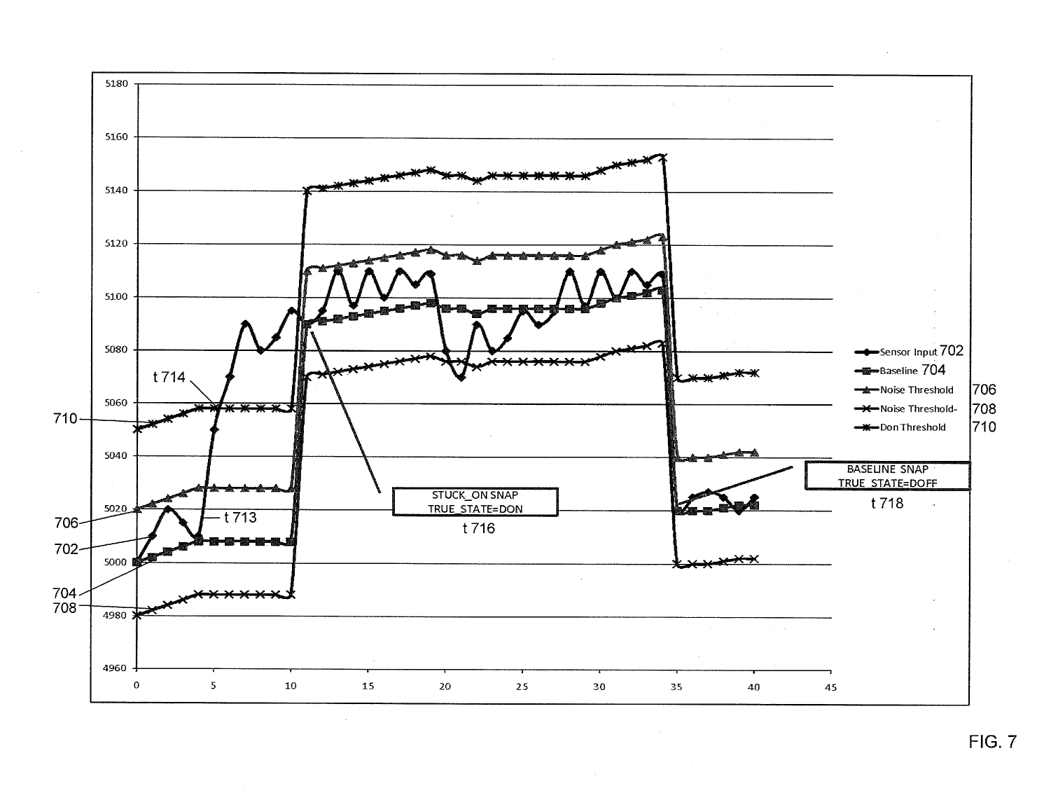

FIG. 5 illustrates a plot of signal values and baseline level values during operation of a process utilizing an active state baseline level in one example of a simulated sensor signal. The horizontal axis shows time and the vertical axis shows signal values. The sensor signal values are for illustrative purposes only, and may represent analog signal voltages or numerical values output from an A/D converter. In the example shown in FIG. 5, a headset application is described wherein a sensor active state occurs when a headset is DON and a sensor inactive state occurs when the headset is DOFF. In further examples however, the apparatus and method illustrated in FIG. 5, as well as in FIG. 6 and FIG. 7 described below, are not limited to headset applications, but any application utilizing a touch sensor.

Referring to FIG. 5, a sensor signal 502 is plotted which increases in value corresponding to a touch action at the touch sensor. The sensor signal 502 maintains an increased value corresponding to a continuing touch action, and then decreases in value corresponding to removal of the touch action. Also illustrated in FIG. 5 are plots of a DON threshold 514, DOFF baseline level 504, DOFF noise threshold 508, DON baseline level 506, lower DON noise threshold 510, and upper DON noise threshold 512.

The value of the DON baseline level 506 is adjusted responsive to the values of sensor signal 502 when operating in a DON tracking mode. In the example illustrated in FIG. 5, the DOFF baseline level 504 is correspondingly adjusted during the DON tracking mode responsive to an adjustment in the DON baseline level 506.

At a time t 513, sensor signal 502 is below DON threshold 514 and operating in normal tracking mode whereby DON and DOFF state are determined utilizing DOFF baseline level 504. At a time t 515, sensor signal 502 exceeds DON threshold 514 and the system indicates a DON state. At a time t 516, the system enters a DON tracking mode, where time t 516 occurs a predetermined time after time t 515. The DON baseline level 506 is set to the value of the sensor signal 502 at the time the DON tracking mode is entered. During DON tracking mode, the DON baseline level 506 is adjusted responsive to the values of sensor signal 502. During DON tracking mode, the DOFF baseline level 504 is adjusted responsive to adjustment of the DON baseline level 506.

Where the value of sensor signal 502 drops below a lower DON noise threshold 510 or exceeds an upper DON noise threshold 512, the system departs DON tracking mode and returns to normal tracking mode. At time t 518, sensor signal 502 drops below lower DON noise threshold 510 and the system returns to normal tracking mode. At time t 520, sensor signal 502 exceeds lower DON noise threshold 510. At time t 522, the system reenters the DON tracking mode. At time t 524, sensor signal 502 falls below DON threshold 514 and the system indicates a DOFF state and returns to normal tracking mode. Hysteresis techniques may be employed related to DON threshold 514 to prevent undesirable shifting of states.

FIG. 6 illustrates a plot of signal values and baseline level values during operation of a process utilizing an active state baseline level in a further example of a simulated sensor signal. In overview, FIG. 6 shows a sensor signal 602 plot which increases in value corresponding to a touch action at the touch sensor. The sensor signal 602 maintains an increased value corresponding to a continuing touch action, and then decreases in value corresponding to removal of the touch action. Also illustrated in FIG. 6 are plots of a DON threshold 614, DOFF baseline level 604, DOFF noise threshold 608, DON baseline level 606, lower DON noise threshold 610, and upper DON noise threshold 612.

The value of the DON baseline level 606 is adjusted responsive to the values of sensor signal 602 when operating in a DON tracking mode. In the example illustrated in FIG. 6, the DOFF baseline level 604 is adjusted responsive to any adjustments in the DON baseline level 606 upon a switch from DON tracking mode to normal tracking mode.

At a time t 613, sensor signal 602 is below DON threshold 614 and operating in normal tracking mode whereby DON and DOFF state are determined utilizing DOFF baseline level 604. At a time t 615, sensor signal 602 exceeds DON threshold 614 and the system indicates a DON state. At a time t 616, the system enters a DON tracking mode, where time t 616 occurs a predetermined time after time t 615. The DON baseline level 606 is set to the value of the sensor signal 602 at the time the DON tracking mode is entered. During DON tracking mode, the DON baseline level 606 is adjusted responsive to the values of sensor signal 602.

Where the value of sensor signal 602 drops below a lower DON noise threshold 610 or exceeds an upper DON noise threshold 612, the system departs DON tracking mode and returns to normal tracking mode. At time t 618, sensor signal 602 drops below lower DON noise threshold 610 and the system returns to normal tracking mode. Upon return to normal tracking mode at time t 618, the DOFF baseline level 604 is adjusted responsive to the previous adjustment of the DON baseline level 606.

At time t 620, sensor signal 602 exceeds lower DON noise threshold 610. At time t 622, the system reenters the DON tracking mode. At time t 624, sensor signal 602 falls below DON threshold 614 and the system indicates a DOFF state and returns to normal tracking mode. Upon return to normal tracking mode at time t 624, the DOFF baseline level 604 is adjusted responsive to the previous adjustment of the DON baseline level 606.

FIG. 7 illustrates a plot of signal values and baseline level values during operation of a process for adjustment of a baseline level in one example. In overview, FIG. 7 shows a sensor signal 702 plot which increases in value corresponding to a touch action at the touch sensor. The sensor signal 702 maintains an increased value corresponding to a continuing touch action, and then decreases in value corresponding to removal of the touch action. Also illustrated in FIG. 7 are plots of a DON threshold 710, baseline level 704, lower noise threshold 708, and upper noise threshold 706.

At a time t 713, sensor signal 702 is below DON threshold 710 and DON and DOFF state are determined utilizing baseline level 704 and DON threshold 710. At a time t 714, sensor signal 702 exceeds DON threshold 710 and the system indicates a DON state. At a time t 716, the system identifies a stuck-on activity state. Upon determination of the stuck-on activity state at time t 716, the baseline level 704 is set to the value of the sensor signal 702 (also referred to as a “stuck-high baseline snap”). During the stuck-on activity state, the baseline level 704 is further adjusted responsive to the sensor signal 702. Also upon determination of the stuck-on activity state at time t 716, a true-state variable is set to active, indicating that the system is still in a DON state.

At time t 718, sensor signal 702 drops below lower noise threshold 708, and the baseline level 704 is set to the value of the sensor signal 702 in a stuck-low baseline snap. The true-state variable is set to inactive, indicating that the system is in a DOFF state.

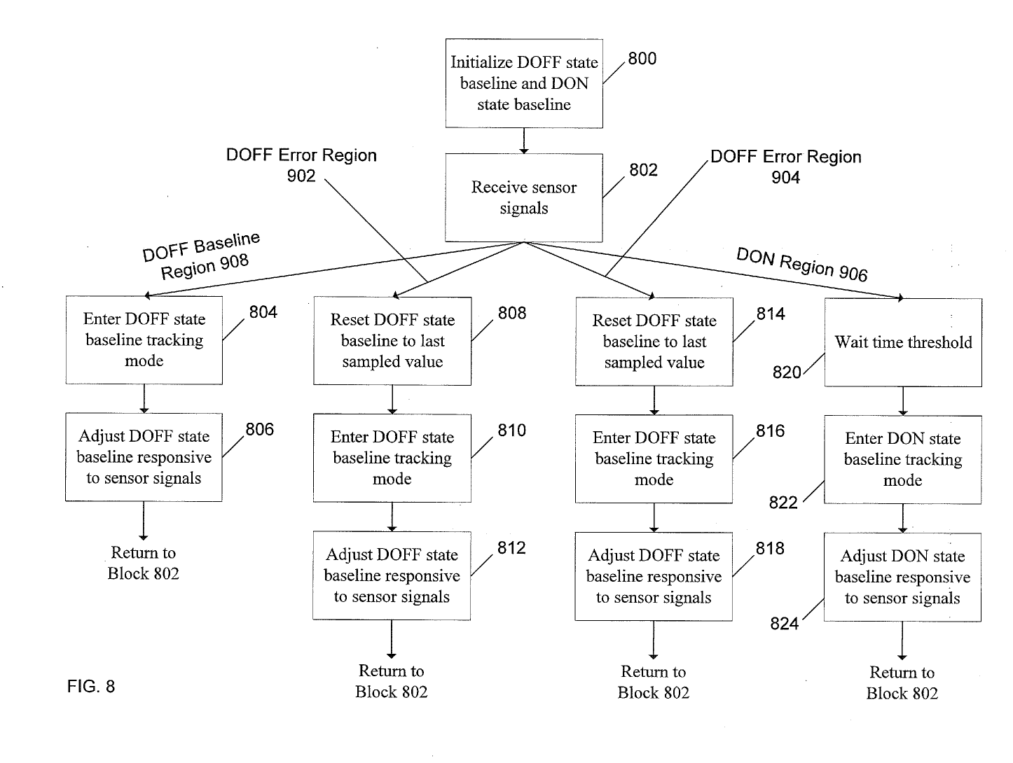

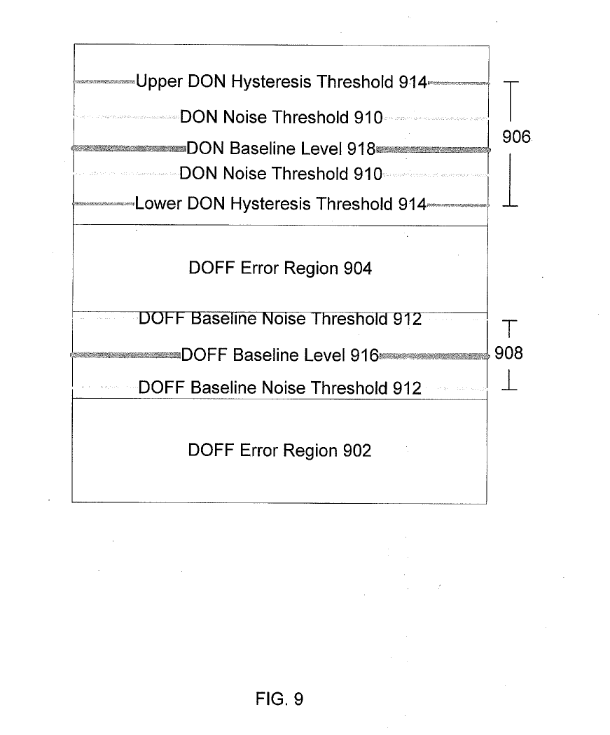

FIG. 8 is a flow diagram illustrating a process for a sensor utilizing an active state baseline tracking mode and inactive state baseline tracking mode in one example. FIG. 9 is a diagram illustrating various operating regions for a touch sensor in one example. In the example shown in FIG. 8 and FIG. 9, a headset application is described wherein a sensor active state occurs when a headset is worn on a user ear and a sensor inactive state occurs when the headset is not worn on the user ear. In further examples however, the apparatus and method illustrated in FIG. 8 and FIG. 9 are not limited to headset applications, but any application utilizing a touch sensor.

In one example, determining a DOFF sensor state includes determining whether the sampled sensor signal values indicate a first error state by monitoring whether the sensor signal values are below a first threshold value below the DOFF state baseline level for a first time threshold, where the DOFF state baseline level is set to the last sampled sensor signal value upon determination of the first error state. It is determined whether the sensor signal values indicate a second error state by monitoring whether the sampled sensor signal values are above a second threshold value above the DOFF state baseline and below a third threshold value below a DON state baseline level for a second time threshold. The DOFF state baseline level is set to the last sampled sensor signal value upon determination of the second error state.

Referring to FIG. 8, at block 800, the DOFF state baseline and DON state baseline are initialized. The baselines may be initialized at power-up automatically, through user action, or extracted from an EEPROM table. At block 802, sensor signals are sampled and received. Sensors are scanned every MEASURE_INTERVAL seconds. Where the headset includes multiple touch sensors, on the each scan of sensors, each sensor signal is evaluated to see which region it falls into based on its baseline value. Received sensor signals are processed to identify an operation region the signals fall into.

There are several levels, thresholds and signal regions of interest to the sensing process. Referring to FIG. 9, sampled sensor signal values are received and identified as falling into one of four regions: a DOFF baseline region 908, DOFF error region 902, DOFF error region 904, and a DON region 906. DOFF error region 902 and 904 indicate a DOFF state, but also that there may be a possible error.

When the headset is not worn, the sampled sensor signal typically falls in the DOFF baseline region 908, near the DOFF baseline level 916. When worn, the signal ideally falls in the DON region 906 at some DON level.

A threshold must be crossed to define entry into the DON region 906. In order to avoid rapid switching between DON-DOFF states, hysteresis thresholds 914 are used. If the signal is above the upper hysteresis threshold, DON is declared. If it falls below the lower hysteresis threshold, DOFF is declared. The hysteresis thresholds must be outside the noise threshold 910 of the sampled sensor signal while DON to avoid undesirable switching between states.

The sensitivity of the sensor electrode determines the threshold-baseline spacing. However, because of mechanical and environmental variability, the DOFF baseline level 916 can drift. The danger is that if it drifts towards the DON threshold, the sensitivity increases, which may be undesirable in some applications. If it drifts past the DON threshold, the system is no longer sensing DON/DOFF state. To eliminate drift issues, the sensing method initializes the DOFF baseline level 916 when the sensor is known to be not worn. Changes in the sampled sensor signal are tracked when not worn and the DOFF baseline level 916 is adjusted.

To make sure that the sampled sensor signal change is due to drift and not a real signal due to a conductor (e.g., a user ear), baseline DOFF noise thresholds 912 are defined. As long as the signal is within the baseline region defined by these DOFF noise thresholds 912, the method will track the sampled sensor signal and adapt the DOFF baseline level 916. While the headset is worn, a similar problem of DON baseline level drift can occur. If the drift crosses the lower DON hysteresis threshold 914, it will change state and give a false indication. Therefore, the method must track the DON level as well.

If a conductor is brought near the sensor, and the sampled sensor signal exceeds the baseline DOFF noise threshold 912, but does not reach the upper DON hysteresis threshold 914, it is said to be in DOFF error region 904, being neither in the DON region 906 or the DOFF baseline region 908. Technically, the signal still indicates a DOFF state, but in general, this is an undesirable state. The signal can be in this region due to handling, poor headset fit, or a mechanical change in the headset. No baseline or DON-level tracking occurs here. If in this state for too long, the system may lose its ability to adapt to changes in environment.

Finally, if the sampled sensor signal level is below the baseline beyond the baseline DOFF noise threshold 912, the baseline is incorrect and is in DOFF error region 902. It indicates the DOFF baseline level 916 is set incorrectly and must be corrected.

The discussion above was for a given sensor's DON or DOFF state. In further example, multiple sensors may be used. In one example, when there are multiple sensors indicating DON or DOFF state all sensors must agree for DON, otherwise DOFF. In a further example, all sensors must agree for DON or DOFF, and otherwise stay in current state. In yet another example, a majority of the sensors must agree to declare DON. The choice may be a configurable option in the system.

Referring to FIG. 8 and FIG. 9 together, if the sensor signals fall into a DOFF baseline region 908, the headset state is DOFF. At block 804 the system enters a DOFF state baseline tracking mode. As long as the sensor signal remains in DOFF baseline region 908, a current differential value is accumulated. When the absolute value of the accumulation exceeds a configuration value BASELINE_TRACK_THRESHOLD, the DOFF baseline level 916 is incremented or decremented depending on whether the threshold was exceeded positively or negatively. This effectively works like a time-averaging filter with a timeline approximately equal to BASELINE_TRACK_THRESHOLD/BASELINE_NOISE*MEASURE_INTERVAL. This process tracks environmental changes that affect the baseline. Any sensor signal that deviates outside the DOFF baseline region 908 constitutes an EVENT. The process enters EVENT mode and resets the accumulation. At block 806, the DOFF state baseline is adjusted responsive to the received sensor signals.

If the sensor signals fall into a DOFF error region 902, the headset state is DOFF. At block 808 the DOFF state baseline is reset to the last sampled value. For example, if a sensor signal enters the DOFF error region 902 for a predetermined time threshold, the DOFF baseline level 916 is automatically reset to the last scanned value. DOFF tracking begins anew. This process fixes incorrect baseline level 916 values due to a bad state or mechanical shift causing a change in calibration. In general this should be quick, on the order of one second. After waiting a time threshold, at block 810, the system enters a DOFF state baseline tracking mode. At block 812, the DOFF state baseline is adjusted responsive to the received sensor signals. Any signal that deviates outside the DOFF error region constitutes an EVENT. The process enters EVENT mode and resets the DOFF error region 902 timer.

If the sensor signals fall into a DOFF error region 904, the headset state is also DOFF. At block 814 the DOFF state baseline is reset to the last sampled value. After waiting a time threshold, at block 816, the system enters a DOFF state baseline tracking mode. At block 818, the DOFF state baseline is adjusted responsive to the received sensor signals. If the sensor signal-baseline difference enters DOFF error region 904 (greater than DOFF noise threshold 912 but less than lower DON hysteresis threshold level 914) for a predetermined time threshold, the DOFF baseline level 916 is automatically reset to the last scanned value. DOFF tracking begins anew. This process fixes bad baselines due to a mechanical shift causing a change in calibration. It will unfortunately also occur if the user is handling the unit for an extended period of time. However, the process for DOFF error region 902 will quickly correct this error, and if the time is configured sufficiently long, handling will not be a problem. Any signal that deviates outside the DOFF error region 904 constitutes an EVENT. The process enters EVENT mode and resets the DOFF error region 904 timer.

If the sensor signals fall into a DON region 906, at block 820 the system waits a predetermined time threshold. If the sensor signal enters the DON region 906 by exceeding the lower DON hysteresis threshold 914 for a predetermined time period, the state is DON. As long as the signal does not go below the DON hysteresis threshold 914, this state is maintained.

At block 822 the system enters a DON state baseline tracking mode. After a predetermined time threshold in the DON state, the process enters the DON state baseline tracking mode. The value of the signal is set to the DON baseline level 918 and used to compute a differential value between the signal and DON baseline level 918. As long as the differential signal does not exceed the DON noise threshold 910, the current differential value is accumulated. When the absolute value of the accumulation exceeds a configuration value BASELINE_TRACK_THRESHOLD, the baseline is incremented or decremented depending on whether the threshold was exceeded positively or negatively. This effectively works like a time-averaging filter with a timeline approximately equal to DON_TRACK_THRESHOLD/DON_NOISE*MEASURE_INTERVAL. This process tracks environmental changes that affect the baseline.

At block 824, the DON state baseline is adjusted responsive to the received sensor signals. Any differential signal that deviates outside the DON noise threshold 910 constitutes an EVENT. The process enters EVENT mode and resets the accumulation. Following block 806, block 812, block 818, and block 824, the process returns to block 802.

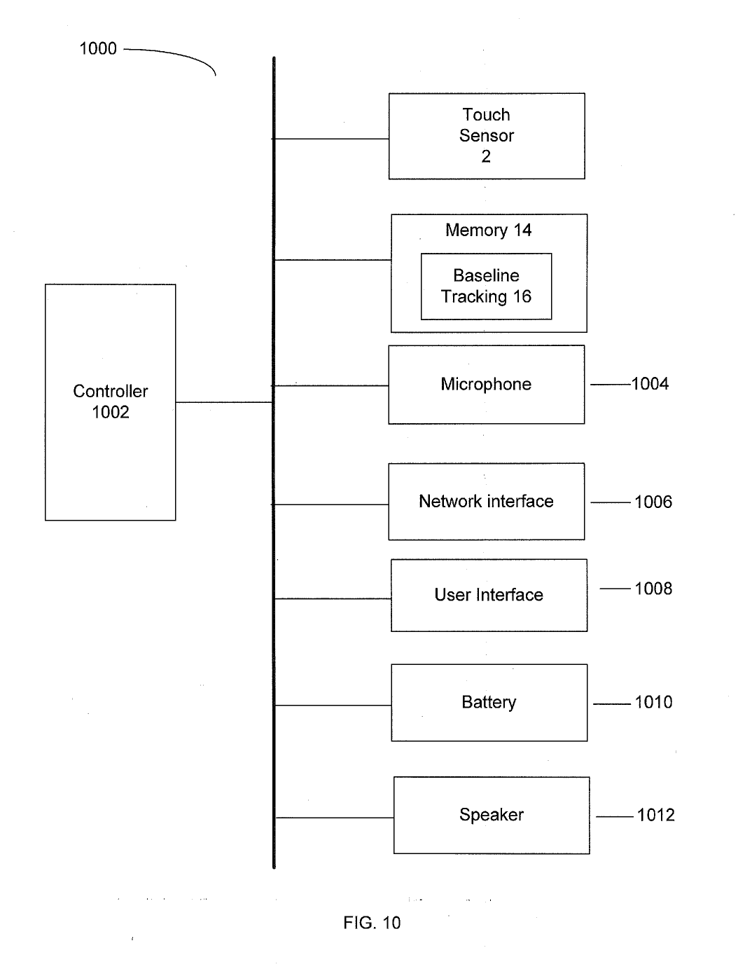

The touch sensor described above may be advantageously implemented in a variety of devices. FIG. 10 illustrates a block diagram of a headset 1000 utilizing the touch sensor system shown in FIG. 1. Headset 1000 includes a controller 1002 operably coupled to a touch sensor 2, a memory 14, a microphone 1004, a network interface 1006, user interface 1008, battery 1010, and a speaker 1012. In the example shown in FIG. 10, certain components of the touch sensor system shown in FIG. 1 are integrated with components at headset 1000.

Controller 1002 controls the operation of the headset 1000 and allows for processing data, and in particular managing data between touch sensor 2 and memory 14 for determining the DON or DOFF state of headset 1000. In one example, controller 1002 is a high performance, highly integrated, and highly flexible system-on-chip (SOC). Controller 1002 may include a variety of separate or integrated processors (e.g., digital signal processors), with conventional CPUs being applicable, and controls the operation of the headset 1000 by executing programs in memory 14, including baseline tracking application 16 as described above to adjust both a DON baseline and DOFF baseline responsive to signals received from touch sensor 2. Memory 14 may include a variety of memories, and in one example includes SDRAM, ROM, flash memory, or a combination thereof. Memory 14 may further include separate memory structures or a single integrated memory structure. Memory 14 may also store signals or data from touch sensor 2.

The network interface 1006 may communicate using any of various protocols known in the art for wireless or wired connectivity. User interface 1008 allows for communication between a headset user and the headset 1000, and in one example includes an audio and/or visual interface such that a prompt may be provided to the user's ear and/or an LED may be lit. For example, an audio interface may be initiated by the headset upon detection that the headset is DON. In addition, the audio interface can provide feedback to the user in the form of an audio prompt (e.g., a tone or voice) through the speaker 1012 indicating the headset 1000 is in place (i.e., DON).

While the exemplary embodiments of the present invention are described and illustrated herein, it will be appreciated that they are merely illustrative and that modifications can be made to these embodiments without departing from the spirit and scope of the invention. The methods described herein may be implemented in either hardware or software. A computer readable storage medium may store instructions that when executed by a computer cause the computer to perform any of the methods for touch sensing described herein. Thus, the scope of the invention is intended to be defined only in terms of the following claims as may be amended, with each claim being expressly incorporated into this Description of Specific Embodiments as an embodiment of the invention.

What is claimed is:

1. A method for determining sensor touch activity comprising:
receiving a series of sensor signal values;
determining a no touch inactive sensor state from the series of sensor signal values utilizing an inactive state baseline level;
adjusting the inactive state baseline level responsive to the series of sensor signal values during the no touch inactive sensor state;
determining an active sensor touch state from the series of sensor signal values utilizing the inactive state baseline level;
establishing an active state baseline level during the active sensor touch state, where the active state baseline level is adjusted responsive to the sampled sensor signal values during the active sensor touch state; and
determining a no touch inactive sensor state or an active sensor touch state from the series of sensor signal values utilizing the active state baseline level during the active sensor touch state.

2. The method of claim 1, further comprising waiting a fixed time period following determination of the active sensor touch state prior to establishing the active state baseline level.

3. The method of claim 1, further comprising:
terminating determining a no touch inactive sensor state or an active sensor touch state from the series of sensor signal values utilizing the active state baseline level during the active sensor touch state if a sampled sensor signal value in the series of sensor signal values exceeds a predetermined threshold value; and
determining a no touch inactive sensor state or an active sensor touch state from the series of sensor signal values utilizing the inactive state baseline level.

4. The method of claim 3, further comprising adjusting the inactive state baseline level responsive to a previous adjustment of the active state baseline level after terminating determining a no touch inactive sensor state or an active sensor touch state from the series of sensor signal values utilizing the active state baseline level and prior to determining a no touch inactive sensor state or an active sensor touch state from the series of sensor signal values utilizing the inactive state baseline level.

5. The method of claim 3, wherein the predetermined threshold value is a predetermined noise level value associated with an active sensor touch state.

6. The method of claim 1, wherein the no touch inactive sensor state corresponds to a headset DOFF state and the active sensor touch state corresponds to a headset DON state.

7. The method of claim 1, further comprising resetting the inactive state baseline level to a last sampled value if the last sampled value in the series of sensor signal values exceeds a predetermined threshold above or below the inactive state baseline level during a no touch inactive sensor state.

8. The method of claim 1, wherein determining a no touch inactive sensor state from the series of sensor signal values comprises:
determining whether the series of sensor signal values indicate a first error state comprising monitoring whether the series of sensor signal values are below a first threshold value below the inactive state baseline level for a first time threshold, wherein the inactive state baseline level is set to a last sampled sensor signal value upon determination of the first error state; and
determining whether the series of sensor signal values indicate a second error state comprising monitoring whether the series of sensor signal values are above a second threshold value above the inactive state baseline level and below a third threshold value below an active state baseline level for a second time threshold, wherein the inactive state baseline level is set to a last sampled sensor signal value upon determination of the second error state.

9. The method of claim 1, where the active state baseline level is adjusted responsive to the sampled sensor signal values during the active sensor touch state by incrementing or decrementing the active state baseline level responsive to a time-averaged series of sensor signal values falling above or below the active state baseline level by an amount within a predetermined threshold.

10. The method of claim 1, further comprising adjusting the inactive state baseline level responsive to an adjustment of the active state baseline level.

11. A method for determining sensor touch activity comprising:
sampling a series of sensor signal values;
entering an active sensor touch state associated with user touch activity at a sensor;
setting an active state baseline level during the active sensor touch state;
adjusting the active state baseline level responsive to the series of sensor signal values to establish an adjusted active state baseline level; and
determining a no touch inactive sensor state from the series of sensor signal values utilizing the adjusted active state baseline level.

12. The method of claim 11, wherein setting an active state baseline level comprises sampling a current sensor signal value at a fixed time period after entry into the active sensor touch state.

13. The method of claim 11, further comprising adjusting the active state baseline level responsive to the series of sensor signal values by incrementing or decrementing the active state baseline level responsive to the series of sensor signal values falling above or below the active state baseline value by an amount within a predetermined threshold.

14. The method of claim 11, further comprising:
terminating determining a no touch inactive sensor state from the series of sensor signal values utilizing the active state baseline level if the series of sensor signal values exceeds a predetermined threshold value; and
determining a no touch inactive sensor state or an active sensor touch state from the series of sensor signal values utilizing an inactive state baseline level.

15. The method of claim 11, further comprising adjusting an inactive state baseline level responsive to an adjustment of the active state baseline level.

16. A method for determining sensor touch activity comprising:
receiving a series of sensor signal values;
entering an active sensor touch state tracking mode associated with user touch activity at a sensor, wherein during the active sensor touch state tracking mode an active state baseline level is adjusted responsive to the series of sensor signal values;
determining a no touch inactive sensor state from the series of sensor signal values utilizing the active state baseline level; and
departing the active sensor touch state tracking mode and entering a normal tracking mode if the series of sensor signal values exceed a threshold noise level, wherein during normal tracking mode an inactive state baseline level is utilized to determine touch activity at the sensor.

17. The method of claim 16, further comprising adjusting the inactive state baseline level responsive to the series of sensor signal values.

18. The method of claim 16, further comprising adjusting the inactive state baseline level responsive to the active state baseline level being adjusted.

19. The method of claim 16, further comprising initializing the active state baseline level at a fixed time after entering the active sensor touch state tracking mode.

20. The method of claim 16, wherein during the active sensor touch state tracking mode an active state baseline level is adjusted by incrementing or decrementing the active state baseline level responsive to the series of sensor signal values falling above or below the active state baseline level by an amount within a predetermined threshold.

21. A method for determining sensor touch activity comprising:
receiving a series of sensor signal values;
determining a no touch inactive sensor state from the series of sensor signal values utilizing a baseline level;
adjusting the baseline level responsive to the series of sensor signal values;
determining an active sensor touch state from the series of sensor signal values utilizing the baseline level;
determining a stuck-on activity state;
setting the baseline level to a current sampled sensor signal value responsive to determining the stuck-on activity state, wherein the baseline level is further adjusted using the sampled sensor signal values to produce an adjusted baseline level;
setting a true-state variable to active responsive to determining the stuck-on activity state;
setting the adjusted baseline level to a current sampled sensor signal value responsive to the series of sensor signal values exceeding a predetermined threshold; and
setting the true-state variable to inactive responsive to the series of sensor signal values exceeding the predetermined threshold.

22. The method of claim 21, wherein determining a stuck-on activity state from the series of sensor signal values comprises determining whether a time period of the active sensor touch state exceeds a pre-determined stuck-on time.

23. The method of claim 21, wherein the no touch inactive sensor state corresponds to a headset DOFF state and the active sensor touch state corresponds to a headset DON state
